(19) United States
(12) Patent Application Publication
(10) Pub. No.: US 2010/0262493 A1
(43) Pub. Date: Oct. 14, 2010

(54) ADAPTIVE SOFT KEY FUNCTIONALITY FOR DISPLAY DEVICES

(75) Inventors: Tatu Antero Tahkokallio, Espoo (FI); Henri Johannes Ahti, Espoo (FI); Ivan Mihael Hytonen, Helsinki (FI); Pasi Tuomas Hytonen, Vantaa (FI); Harri Tapio Myllynen, Helsinki (FI)

Correspondence Address: Nokia, Inc., 6021 Connection Drive, MS 2-5-520, Irving, TX, 75039, US

(73) Assignee: NOKIA CORPORATION, Espoo (FI)

(21) Appl. No.: 12/746,016

(22) PCT Filed: Nov. 21, 2008
(86) PCT No.: PCT/IB08/54904

§ 371 Date: Jun. 3, 2010

Related U.S. Application Data
(60) Provisional application No. 60/991,989, filed on Dec. 3, 2007.

(51) Int. Cl. G06F 3/048; G06Q 30/00

(52) U.S. Cl. 705/14.53; 715/835

(57) ABSTRACT

A system, apparatus, method, and computer program product for providing adaptive soft key functionality for display devices are provided. The apparatus includes a processing element configured to provide for a display of a description of a first function of a soft key. The processing element is also configured to monitor interaction with the soft key and to reconfigure the soft key based on the interaction such that actuation of the soft key invokes a second function. The processing element further provides for a display of a description of the second function. In some cases, a display of advertising content may be provided based on the interaction, and the soft key may be configured to perform various functions related to the advertising content. The soft key may control the size and/or position of the advertising content, scroll through advertisements, and/or access websites and call phone numbers associated with the advertising content.

### TECHNOLOGICAL FIELD

Embodiments of the present invention relate generally to user interface technology and, more particularly, relate to a method, apparatus, and computer program product for providing adaptive soft key functionality on display devices.

### BACKGROUND

As the use of display devices for commerce, communication, education, and recreation grows, the number of applications that must be handled by the display devices also increases. For example, a cellular telephone may have the capability to make and receive phone calls, take digital photographs, play music and video files, and access the internet, among many other functions. As a result, users require a greater number of controls in order to properly operate the display device depending upon which application is being used.

Some display devices include a keypad with hardware keys that allow the user to perform certain hard-coded functions, such as dialing a telephone number or scrolling through a displayed menu and selecting a particular entry. As greater functionality becomes required, the hardware user input interface cannot provide for all the user inputs. So-called “soft keys,” or keys that are not hard-coded and are capable of performing more than one function, depending on the operational situation, have been developed to address this issue. For example, on a cellular phone, actuation of a soft key when the phone is idle may access a list of contacts, whereas actuation of the same soft key when the phone is operating as a camera may zoom in on an object or record a picture.

As the function of the soft key does not remain the same, the function is generally described on a portion of the display to help the user operate the display device. For example, the soft key(s) may be located just under the display, and the portion of the display closest to each soft key may provide a brief description of the current function of the soft key, such as “Contacts” or “Zoom In.”

Display devices are increasingly used to communicate and access other display devices, networks, and communication systems. For example, some display devices are configured to receive advertising content to communicate promotions and items of interest to the user of the display device. Upon receiving such advertising content, the user may wish to learn more about the product or service being advertised as quickly as possible, such as with one actuation of a key.

Notwithstanding the prevalence of soft keys, there is always a desire to improve the ease and efficiency with which a user interacts with a display device. This desire is particularly apparent in conjunction with display devices having soft keys with functionality which may change depending upon the current application.

### BRIEF SUMMARY

A method, apparatus and computer program product are therefore provided for providing adaptive soft key functionality for display devices. In particular, a method, apparatus and computer program product are provided that monitor interaction with user interface elements and reconfigure the soft key(s) to have a second, different functionality based on the interaction. In this way, the soft key may allow the user to control additional functions based on the user's operation of the display device.

In one exemplary embodiment, a method and computer program product for providing adaptive soft key functionality for display devices are provided. The method and computer program product provide for a display of a description of a first function of a soft key, where actuation of the soft key invokes the first function. Interaction with the soft key is monitored, and the soft key is reconfigured based on the interaction such that actuation of the soft key invokes a second function that is different from the first function. A display of a description of the second function is also provided.

In some cases, an amount of time that has passed since a last actuation of the soft key is monitored, and the soft key may be reconfigured after a predetermined amount of time has passed since the last actuation. Reconfiguring the soft key may include disabling the soft key in some circumstances.

Furthermore, a display of advertising content may be provided based on the interaction. In this case, the soft key may be configured to control an aspect of the display of the advertising content, such as the position of the advertising content and/or the size of the advertising content. The soft key may also be configured to scroll from the displayed advertising content to a different item of advertising content. Also, the soft key may be configured to perform a function such as accessing a website associated with the advertising content and/or calling a phone number associated with the advertising content.

In another exemplary embodiment, an apparatus for providing adaptive soft key functionality for display devices is provided. The apparatus may include a processing element. The processing element may be configured to provide for a display of a description of a first function of a soft key, where actuation of the soft key invokes the first function, and to monitor interaction with the soft key. The processing element may also be configured to reconfigure the soft key based on the interaction such that actuation of the soft key invokes a second function that is different from the first function. A description of the second function may be provided by the processing element.

The processing element may further be configured to monitor an amount of time that has passed since a last actuation of the soft key. For example, the processing element may reconfigure the soft key after a predetermined amount of time has passed since the last actuation. The processing element may also be configured to disable the soft key.

In some cases, the processing element is configured to provide for a display of advertising content based on the interaction. The processing element may configure the soft key to control an aspect of the display of the advertising, such as the position of the advertising content and/or the size of the advertising content. The processing element may configure the soft key to scroll from the displayed advertising content to a different item of advertising content in some cases. Also, the processing element may configure the soft key to perform a function such as accessing a website associated with the advertising content and/or calling a phone number associated with the advertising content.

In another exemplary embodiment, an apparatus for providing adaptive soft key functionality for display devices is provided. The apparatus includes means for providing for a display of a description of a first function of a soft key, where actuation of the soft key invokes the first function, and means for monitoring interaction with the soft key. The apparatus further includes means for reconfiguring the soft key based on the interaction such that actuation of the soft key invokes a second, different function, as well as means for providing for a display of a description of the second function.

In another exemplary embodiment, a system for providing adaptive soft key functionality for display devices is provided. The system includes an apparatus configured to display a description of a first function of a soft key and a description of a second function of the soft key, as well as a remote content source configured to receive data from the apparatus and to transmit content to the apparatus according to the data received. The second function may be based at least in part on the content transmitted from the remote content source to the apparatus. In some cases, the remote content source is configured to transmit content including the description of the second function to the apparatus.

### BRIEF DESCRIPTION OF THE SEVERAL VIEWS OF THE DRAWING(S)

Having thus described embodiments of the invention in general terms, reference will now be made to the accompanying drawings, which are not necessarily drawn to scale, and wherein:

FIG. 1 is a schematic block diagram of a mobile terminal according to an exemplary embodiment;

FIG. 2 is a schematic block diagram of an apparatus for providing adaptive soft key functionality for display devices according to an exemplary embodiment;

FIG. 3 illustrates an apparatus according to an exemplary embodiment;

FIG. 4 illustrates a screenshot of an exemplary display in which description of soft key functions are displayed according to an exemplary embodiment;

FIG. 5A illustrates a screenshot of an exemplary display in which advertising content is provided according to an exemplary embodiment;

FIG. 5B illustrates a screenshot of the display of FIG. 5A in which the advertising content is fully provided according to an exemplary embodiment;

FIG. 6 illustrates a screenshot of an exemplary display in which advertising content is provided according to another exemplary embodiment;

FIG. 7 illustrates a screenshot of an exemplary display in which an indication of a received advertisement is displayed according to an exemplary embodiment;

FIG. 8 illustrates a screenshot of an exemplary display in which an advertising website is accessed according to an exemplary embodiment of the present invention;

FIG. 9 illustrates a screenshot of an exemplary display in which a gray layer is applied to a former application according to an exemplary embodiment;

FIG. 10 illustrates a screenshot of an exemplary display in an advertising mode in which a rotating logo is displayed according to an exemplary embodiment;

FIG. 11 illustrates a screenshot of an exemplary display in an advertising mode in which cascading advertisements are displayed according to an exemplary embodiment; and

FIG. 12 is a block diagram according to an exemplary method for providing adaptive soft key functionality for display devices according to an exemplary embodiment.

### DETAILED DESCRIPTION

Embodiments of the present invention will now be described more fully hereinafter with reference to the accompanying drawings, in which some, but not all embodiments of the invention are shown. Indeed, the invention may be embodied in many different forms and should not be construed as limited to the embodiments set forth herein; rather, these embodiments are provided so that this disclosure will satisfy applicable legal requirements. Like reference numerals refer to like elements throughout.

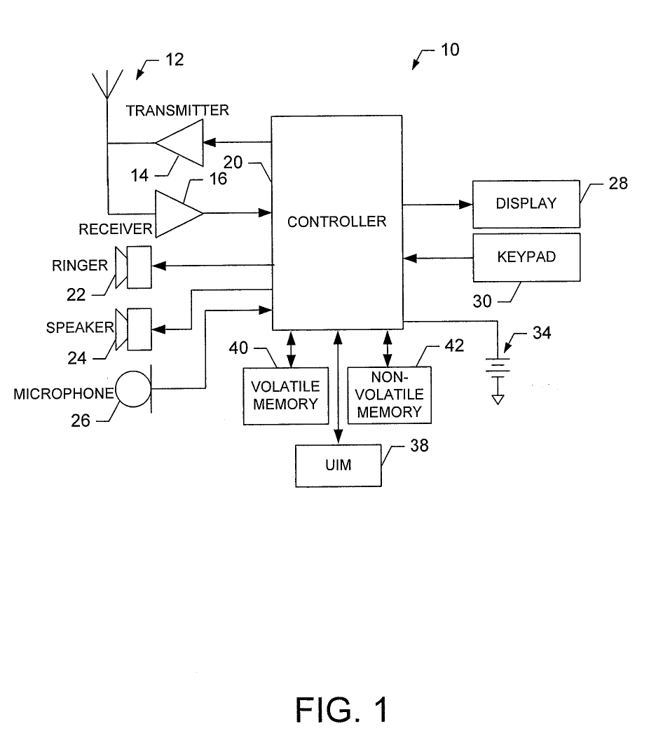

FIG. 1 illustrates a block diagram of a mobile terminal 10 that would benefit from embodiments of the present invention. It should be understood, however, that a mobile telephone as illustrated and hereinafter described is merely illustrative of one type of mobile terminal that would benefit from embodiments of the present invention and, therefore, should not be taken to limit the scope of embodiments of the present invention. While one embodiment of the mobile terminal 10 is illustrated and will be hereinafter described for purposes of example, other types of mobile terminals, such as portable digital assistants (PDAs), pagers, mobile computers, mobile televisions, gaming devices, laptop computers, cameras, video recorders, interne devices, GPS devices and other types of voice and text communications systems, can readily employ embodiments of the present invention. Furthermore, other apparatus including devices that are not mobile may also readily employ embodiments of the present invention.

The apparatus and method of embodiments of the present invention will be primarily described below in conjunction with mobile communications applications. However, it should be understood that the apparatus and method of embodiments of the present invention can be utilized in conjunction with a variety of other display devices, both in the mobile communications industries and outside of the mobile communications industries.

The mobile terminal 10 includes an antenna 12 (or multiple antennae) in operable communication with a transmitter 14 and a receiver 16. The mobile terminal 10 further includes a processing element, such as a controller 20 or other type of processor or computing device, that provides signals to and receives signals from the transmitter 14 and receiver 16, respectively. The signals include signaling information in accordance with the air interface standard of the applicable cellular system, and also user speech, received data and/or user generated data. In this regard, the mobile terminal 10 is capable of operating with one or more air interface standards, communication protocols, modulation types, and access types. By way of illustration, the mobile terminal 10 is capable of operating in accordance with any of a number of first, second, third and/or fourth-generation communication protocols or the like. For example, the mobile terminal 10 may be capable of operating in accordance with second-generation (2G) wireless communication protocols IS-136 (Time Division Multiple Access (TDMA)), Global System for Mobile communications (GSM), and IS-95 (Code Division Multiple Access (CDMA)), or with third-generation (3G) wireless communication protocols, such as Universal Mobile Telecommunications System (UMTS), CDMA2000, Wideband CDMA (WCDMA) and Time Division-Synchronous Code Division Multiple Access (TD-SCDMA), with fourth-generation (4G) wireless communication protocols or the like.

It is understood that the apparatus, such as the controller 20, includes circuitry desirable for implementing audio and logic functions of the mobile terminal 10. For example, the controller 20 may be comprised of a digital signal processor device, a microprocessor device, and various analog to digital converters, digital to analog converters, and other support circuits. Control and signal processing functions of the mobile terminal 10 are allocated between these devices according to their respective capabilities. The controller 20 thus may also include the functionality to convolutionally encode and interleave message and data prior to modulation and transmission. The controller 20 can additionally include an internal voice coder, and may include an internal data modem. Further, the controller 20 may include functionality to operate one or more software programs, which may be stored in memory. For example, the controller 20 may be capable of operating a connectivity program, such as a conventional Web browser. The connectivity program may then allow the mobile terminal 10 to transmit and receive Web content, such as location-based content and/or other web page content, according to a Wireless Application Protocol (WAP), Hypertext Transfer Protocol (HTTP) and/or the like, for example.

The mobile terminal 10 may also comprise a user interface including an output device such as a ringer 22, a conventional earphone or speaker 24, a microphone 26, a display 28, and a hardware user input interface, all of which are coupled to the controller 20. The hardware user input interface, which allows the mobile terminal 10 to receive data, may include any of a number of devices allowing the mobile terminal 10 to receive data, such as a keypad 30, a touch display (not shown) or other input device. In embodiments including the keypad 30, the keypad 30 may include the conventional numeric (0-9) and related keys (#, *), and other keys used for operating the mobile terminal 10. Alternatively, the keypad 30 may include a conventional QWERTY keypad arrangement. The keypad 30 may also include various soft keys with associated functions. In addition, or alternatively, the mobile terminal 10 may include an interface device such as a joystick or other hardware user input interface. The mobile terminal 10 further includes a battery 34, such as a vibrating battery pack, for powering various circuits that are required to operate the mobile terminal 10, as well as optionally providing mechanical vibration as a detectable output.

The mobile terminal 10 may further include a user identity module (UIM) 38. The UIM 38 is typically a memory device having a processor built in. The UIM 38 may include, for example, a subscriber identity module (SIM), a universal integrated circuit card (UICC), a universal subscriber identity module (USIM), a removable user identity module (R-UIM), etc. The UIM 38 typically stores information elements related to a mobile subscriber. In addition to the UIM 38, the mobile terminal 10 may be equipped with memory. For example, the mobile terminal 10 may include volatile memory 40, such as volatile Random Access Memory (RAM) including a cache area for the temporary storage of data. The mobile terminal 10 may also include other non-volatile memory 42, which can be embedded and/or may be removable. The non-volatile memory 42 can additionally or alternatively comprise an EEPROM, flash memory or the like, such as that available from the SanDisk Corporation of Sunnyvale, Calif., or Lexar Media Inc. of Fremont, Calif. The memories can store any of a number of pieces of information, and data, used by the mobile terminal 10 to implement the functions of the mobile terminal 10. For example, the memories can include an identifier, such as an international mobile equipment identification (IMEI) code, capable of uniquely identifying the mobile terminal 10.

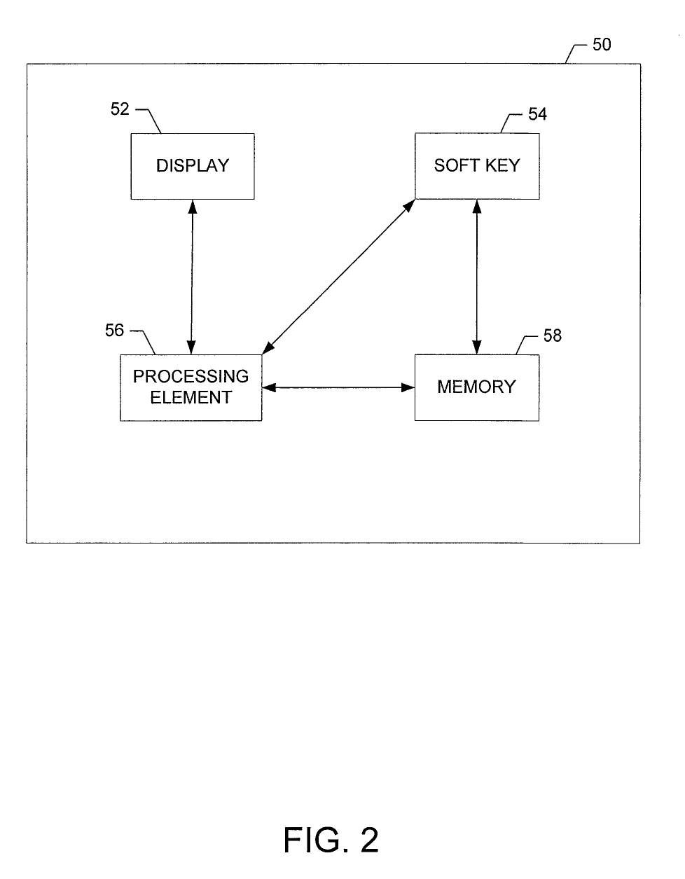

An exemplary embodiment of the invention will now be described with reference to FIG. 2, in which certain elements of an apparatus for providing adaptive soft key functionality for display devices are illustrated. The apparatus of FIG. 2 may be employed, for example, in conjunction with the mobile terminal 10 of FIG. 1. However, it should be noted that the apparatus of FIG. 2, may also be employed in connection with a variety of other devices, both mobile and fixed, and therefore, embodiments of the present invention should not be limited to application on devices such as the mobile terminal 10 of FIG. 1. It should also be noted that while FIG. 2 illustrates one example of a configuration of an apparatus for providing adaptive soft key functionality, numerous other configurations may also be used to implement embodiments of the present invention. Furthermore, although soft keys are used throughout the description to explain embodiments of the present invention, it should be understood that embodiments may provide adaptive functionality for hard keys, as well, such as navigation keys. For example, “Up” and “Down” navigation keys may have a first function of scrolling up and down through an application's text (such as a text message or Contacts list) but may have a second function of scrolling through different content, such as an advertisement, as described below.

Referring now to FIG. 2, an apparatus 50 for providing adaptive soft key functionality for display devices is illustrated. The apparatus 50 may include or otherwise be in communication with a display 52 (e.g., the display 28 of FIG. 1), one or more soft keys 54, means, such as a processing element 56 (e.g., the controller 20 of FIG. 1), for driving the display 52 and for monitoring and configuring the soft key(s) 54, and a memory device 58. The memory 58 may include, for example, volatile and/or non-volatile memory (e.g., volatile memory 40 and/or non-volatile memory 42 of FIG. 1). The memory 58 may be configured to store information, data, applications, instructions or the like for enabling the apparatus to carry out various functions in accordance with exemplary embodiments of the present invention. For example, the memory 58 may be configured to buffer input data for processing by the processing element 56. Additionally or alternatively, the memory 58 may be configured to store instructions for execution by the processing element 56, including a software platform for providing for the display of soft key function descriptions upon the display 52 and/or instructions for executing a software application.

The processing element 56 may be embodied in a number of different ways. For example, the processing element 56 may be embodied as a processor, a coprocessor, a controller or various other processing means or devices including integrated circuits such as, for example, an ASIC (application specific integrated circuit). In an exemplary embodiment, the processing element 56 may be configured to execute instructions stored in the memory 58 or otherwise accessible to the processing element 56.

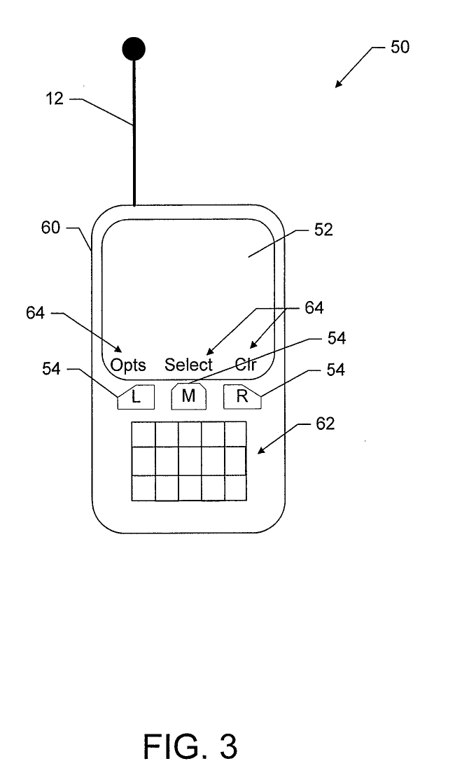

Referring to FIG. 3, the apparatus 50, which may include the mobile terminal 10 of FIG. 1, may include a housing 60 carrying an antenna 12, the display 52, and a hardware user input interface 62, such as the keypad 30 of FIG. 1. The hardware user input interface 62 may be configured in various ways to include any number of keys, as well as other user inputs such as joysticks, levers, touchpads, switches, etc. In FIG. 3, for example, the hardware user input interface 62 includes 15 keys, which may be alpha-numeric keys.

The housing 60 also carries at least one soft key 54. In FIG. 3, there are three soft keys 54 located just below the display 52. The soft keys 54 may be designated as a Left Soft Key (L), Middle Soft Key (M), and Right Soft Key (R). A portion of the display 52 close to each soft key 54 may be reserved as a soft key description area 64. In each soft key description area 64, a brief description of each corresponding soft key may be provided, e.g., by the processing element 56. For example, actuating the Left Soft Key (L) may cause an Options menu to be provided on the display 52. To make the user aware of this functionality, the abbreviation “Opts” may be provided in the corresponding soft key description area 64, as shown. Similarly, the Middle Soft Key (M) may select a highlighted item, and the Right Soft Key (R) may clear a selection or bring the user to a previous screen, in which case “Select” and “Clr” may be provided in the corresponding soft key description areas 64 of the display, respectively.

The processing element 56 of the apparatus 50 is thus configured to provide for a display of a description of a first function of each soft key 54, where actuation of the soft key 54 invokes that particular function. Furthermore, the processing element 56 is configured to monitor interaction with the soft key 54 and to reconfigure that soft key 54 based on the interaction such that actuation of the same soft key 54 (following reconfiguration) invokes a second, different function. A description of the second function is provided for display by the processing element 56, e.g., replacing the description of the first function in the soft key description area 64. In some cases, only the appearance of the soft key description area 64 may be reconfigured to indicate the second function, such as through a different color, size, font, or shape of the soft key description area 64.

For example, the processing element 56 may be configured to monitor the amount of time that has passed since the last actuation of the soft key 54. In this way, after a certain amount of time has passed since a user last actuated the soft key 54 (such as after one minute, five minutes, half an hour, etc.), the processing element 56 may be configured to reconfigure the soft key 54 such that actuation of the soft key now causes a different function to be performed. As an example, an hour may have passed since the last time the user actuated the Middle Soft Key (M), which may be assigned a first function of “Select.” As a result, the processing element 56 may be configured to disable the Middle Soft Key (M), such that actuation of that key produces no result. Similarly, the Middle Soft Key (M) in the above situation may be reconfigured to have any number of second functions as appropriate, such as “Unlock” to unlock the hardware keys or “Go” to launch a certain application. The amount of time may also be a function of another event or time period, such as the amount of time before a screensaver is invoked, a display turns off, or any other event for which a time period is set by a user or the system. For example, if the apparatus is configured such that a screensaver is invoked after five minutes of idle time, the processing element 56 may be configured to reconfigure the soft key 54 one minute (for example) after the screensaver has been invoked.

In some cases, the soft keys 54 may be configured to have several functions, depending on the situation and/or the operation of the apparatus. In other words, the soft keys 54 may be reconfigured by the processing element 56 a number of times, such that the same soft key may also have a third function, a fourth function, a fifth function, etc. as appropriate for the convenience of the user. Each of the functions may be different than the other functions, and a description of the particular function may be provided in the soft key description area 64 as previously described.

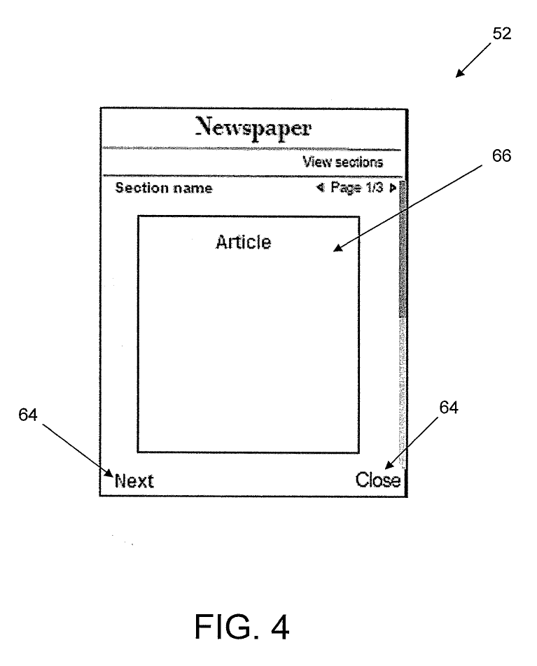

In some cases, the processing element 56 may be configured to provide for a display of advertising content based on the interaction that is monitored. Turning to FIG. 4, for example, a user may be using a mobile terminal incorporating embodiments of the present invention to access a newspaper article 66, e.g., from an internet website. The article 66 may be provided on the display 52 by the processing element 56 such that the user can read the article 66. One or more of the soft keys 54 may have a first function allowing the user to scroll to the next page of the article 66 as it is being read, minimize the article 66 (i.e., make the article 66 take up less space on the display 52), close the article 66, and/or other functions for manipulating the article 66 and facilitating the user's experience. Such first functions may be described in the corresponding soft key description areas 64, as previously discussed.

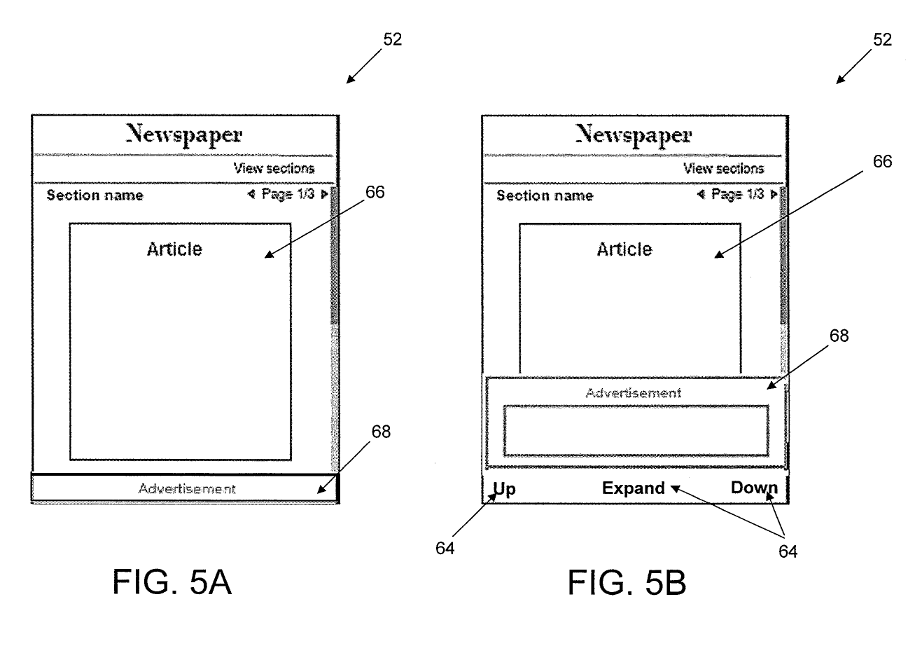

The processing element 56 may be monitoring the user's interaction with one or more of the soft keys 54, such as the Left Soft Key (L) (which, in the example of FIG. 4, allows the user to go to the next page). If the user has not actuated the Left Soft Key (L) for ten minutes or more, for example, the processing element 56 may provide for a display of advertising content 68, as shown in FIGS. 5A and 5B. In other words, the passage of ten minutes since the user last turned the page or since a screensaver provided upon the display was invoked may indicate that the user is not currently reading the article 66, in which case the presentation of an advertisement 68 would be less disruptive than if the user were currently engaged in reading. When the user comes back to the article 66 in this scenario, he will notice the advertisement 68 and can deal with it as appropriate.

Advertising content may include any form of promotional, educational, and/or commercial information. The content may be in text format only, or it may include one or more forms of media content such as pictures, photos, music, and video. Other types of content may also be displayed in addition to or instead of advertising content. For example, the processing element 56 may provide for the display of WidSets or user defined content (such as weather forecasts, stock market reports, currently playing music, Instant Messaging presences, etc.), among other types of content.

The advertisement 68 may be presented on the display 52 in various ways. For example, the advertisement 68 may slide from the bottom of the display, covering the soft key description area at least momentarily. While the advertisement 68 is opening, one or more of the soft keys may continue to perform their first function(s) (such as turning to the next page in the article 66). Once the advertisement 68 is fully rendered, for example as shown in FIG. 5B, the processing element 56 may configure one or more of the soft keys 54 to control an aspect of the display of the advertising content 68, such as to change the position of the advertisement 68 on the display 52 or to adjust the size of the advertisement 68. For example, the second function assigned to the Left Soft Key (L) (and described in the corresponding soft key description area 64) may be “Up,” and the second function assigned to the Right Soft Key (R) may be “Down.” Alternatively or in addition, the Middle Soft Key (M) may be assigned a second function of “Expand.”

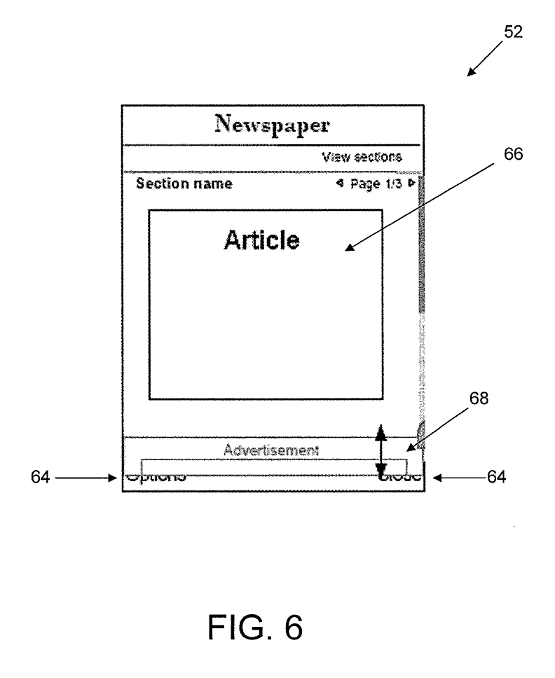

In other embodiments, the advertisement 68 may slide from left to right (or vice versa), for example as scrolling text, or may appear as a progress bar. Furthermore, the advertising content may cover part or all of the soft key description area 64 and the main portion of the display when it is provided to the user, as shown in FIG. 6. Many types of transitions may be used for initially providing the advertising content 68 as well as for removing the advertising content 68 from the display. In FIG. 6, for example, the advertising content 68 expands upwards and downwards, as shown by the double arrows.

In some cases, the advertisement 68 may be provided on the display 52 for a predetermined amount of time, during which the soft key description areas may be hidden. After the time has passed, such as after 5-10 seconds, the processing element 56 may cause the advertisement 68 to slide back down towards the bottom of the display 52, allowing the user to resume reading and/or controlling the article 66 (rather than the advertisement 68). User interaction with one or more of the soft keys 54 may inform the manner in which the advertisement 68 is provided and removed. For example, if there has been no actuation of the soft key(s) 54, the advertisement 68 may slide down towards the bottom of the display 52 slowly, and the soft key(s) may retain the second function (i.e., control of the advertisement 68) until the advertisement 68 has fully receded. Thus, in this case, actuation of a soft key 54 may cause the advertisement 68 to reappear, and the advertisement 68 may not slide off the display 52 again until the predetermined amount of time has passed once more.

In other cases, the soft key may retain its first function even if the advertising content covers or partially covers the corresponding soft key description area 64. For example, if the soft keys are idle for a certain time, advertising content may be presented in the soft key description area, at least partially covering up the description of the first function. However, upon actuation of the soft key, the corresponding first function may still be invoked. Furthermore, one of the soft keys, such as the Middle Soft Key (M), may be reconfigured so as to provide the user with the ability to focus on the advertising content such that the other soft keys may be used to manipulate and/or perform functions related to the advertising content. In this case, a user may actuate of the Middle Soft Key (M) to change focus to the advertising content and then actuate the Left Soft Key (L) or Right Soft Key (R) to control an aspect of the advertising content via the second function of the Left or Right Soft Key (L), (R). In this way, the user may provide input as to which function (first or second) is desired. Upon actuating the Middle Soft Key (M) to change focus in the example above, the soft key description area may also provide a display of a description of the second function of the corresponding soft keys to aid a user in manipulating the advertising content.

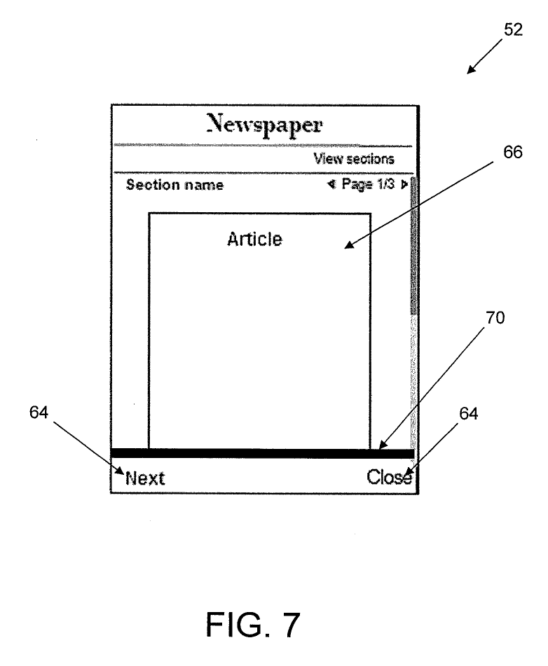

Once the advertisement 68 has been moved off the display 52, for example after the predetermined amount of time has passed, the processing element 56 may provide for an indication of the presence of the advertisement. For example, as shown in FIG. 7, the top border 70 of the advertisement frame (e.g., 5 pixels thick) may be left visible at the bottom of the display 52 as an indication of the advertisement. The indication may have a distinctive appearance, such as a certain color, thickness, or design, to remind the user of its purpose. In this way, if the user was not looking at the display 52 when the advertisement first appeared and then receded, the indication would make the user aware that he has received advertising content. The user may then access the advertisement in various ways, such as by scrolling down (using soft keys or hardware keys) or actuating a soft key which may still be configured to perform its second function.

In some cases, the apparatus may receive an advertisement or other content from a remote content source (such as another device, an advertising server, or other server). The remote content source may be configured to receive data from the apparatus (such as a request for content, an identification of the apparatus, etc.) and to transmit content to the apparatus according to the data received. In this way, the processing element may reconfigure the soft key based at least in part on the content transmitted from the remote content source to the apparatus. For example, if the remote content source is an advertising server and transmits an advertisement to the apparatus, the second function of the soft key may relate to access or manipulation of the advertisement. Furthermore, the remote content source may be configured to transmit the description of the second function to the apparatus for provision in the soft key description area (in addition to the content itself). Thus, the content provided on the display as well as the content provided in the soft key description area may both be streamed or otherwise downloaded from the remote content source.

The processing element may in some instances delay presentation of the advertisement or other content to the user for one reason or another. For example, the user may be operating the mobile terminal in a mode that does not allow for presentation of advertisements, or the user may be interacting with the soft keys such that provision of the advertisement on the display would be disruptive to the user. In this situation, the received advertisement may be placed into a buffer (i.e., stored in the memory 58 of FIG. 2) for later display. Thus, when the user has exited the prohibitive application or has finished a certain operation, for example, the saved advertisement may be retrieved from the buffer and provided on the display.

In some embodiments, the processing element may configure a soft key to scroll from advertising content that is displayed to a different item of advertising content via the second function of the soft key. For example, the second function of the Left Soft Key (L) may be to provide previous advertisements upon the display (i.e., by retrieving previously saved advertisements from the memory), and/or the second function of the Right Soft Key (R) may be to access new advertisements from a particular advertising source.

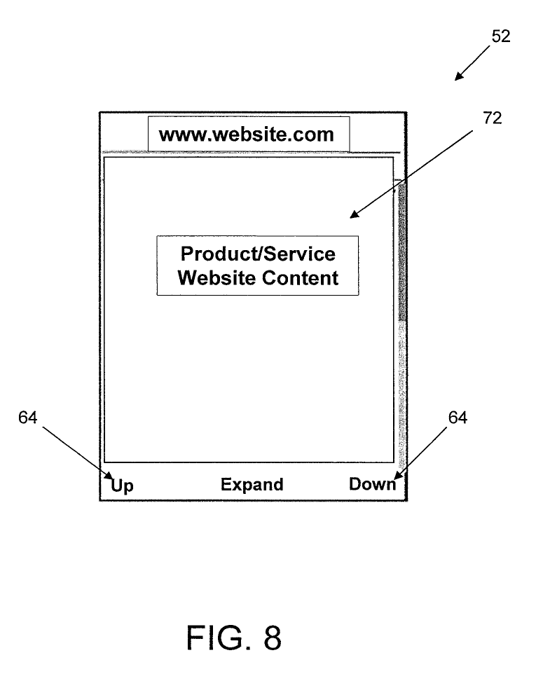

The processing element may also configure one or more of the soft keys to obtain more information about the advertisement for the user. For example, actuation of a soft key, such as the Middle Soft Key (M), may access a website 72 associated with the advertising content, as shown in FIG. 8. Thus, the product/service website 72 may be provided upon the display 52, and the user may be able to navigate the website 72 to find more information about the content advertised (such as the price, the product details, and/or how to order). As another example, actuation of the soft key may cause the mobile terminal to call a phone number associated with the advertisement. In this way, if the user receives an advertisement for a particular restaurant and decides to have dinner there with his family, he can invoke the second function of a particular soft key by pressing the soft key to call the restaurant and make a reservation. Actuation of the soft key may perform many other functions, as well, such as launching another application, initiating a text message, opening a web browser, and others.

In some embodiments, the soft key label area may be used by the active program (such as a browser) for displaying link targets to a user when the user is hovering over (i.e., holding a cursor on top of) a link provided elsewhere on the display. In this case, if the user is viewing a particular website and moves his cursor over a provided link, the soft key description area may provide the web address of the particular link so that the user may view the address without clicking on the link.

The soft key description area may be used to provide the user with other information, as well. For example, pop-ups associated with certain “key words” on a web page (for example, word definitions, explanations, or cross-references) may be provided in the soft key description area when the user hovers over the key word rather than in the body of the display, where the pop-up may obscure the rest of the text. Other types of applications, such as document editors, radio players, music players, and spreadsheet editors, may also use the soft key description area to provide additional information to the user or additional functionality specific to the particular application. For example, a text document editor may provide a description of the font of the text in the soft key description area (e.g., bold, italic, underscore, etc.), may allow the user to change certain formatting options, and/or may provide help functions or information to the user. In a radio player, the soft key description area may be used for Radio Data System (RDS) transmissions, in which small amounts of digital information may be sent using conventional FM broadcasts. Similarly, in a music player, the soft key description area may be used for providing RIYL (Recommended If You Like) music, and in a spreadsheet, the formula corresponding to a selected cell may be displayed (and/or may be editable) in the soft key description area.

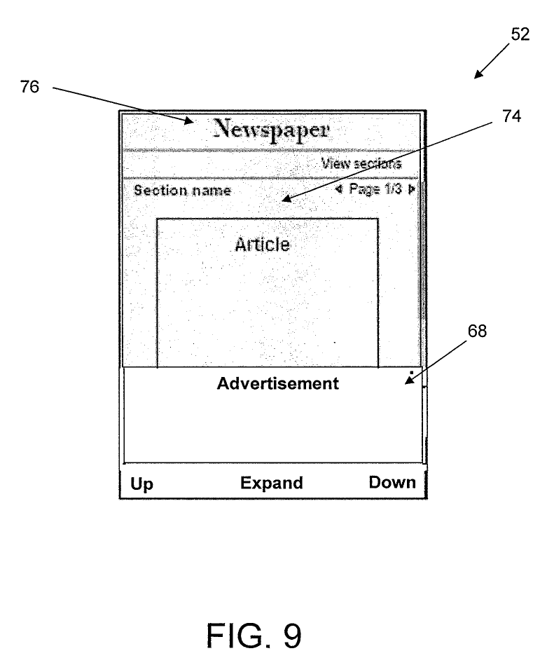

In addition to providing a description of the second function of a soft key (e.g., in the soft key description area 64 shown in FIGS. 3 and 4), the processing element may provide other indications of the functionality of the soft keys. For example, once the processing element has reconfigured the soft keys with a second function that controls the advertising content rather than the application formerly being controlled (e.g., the article 66 of FIGS. 4 and 5), the processing element may provide a transparent gray layer 74 over the former application 76 to visually indicate control of the advertisement 68 rather than the application 76, as shown in FIG. 9. In this case, the gray layer may appear at the same time that the advertisement 68 is provided and/or the soft keys are reconfigured to invoke the second functions. The gray layer 74 may be removed when the advertisement 68 recedes from the display 52 and the focus of the soft keys returns to the application 76.

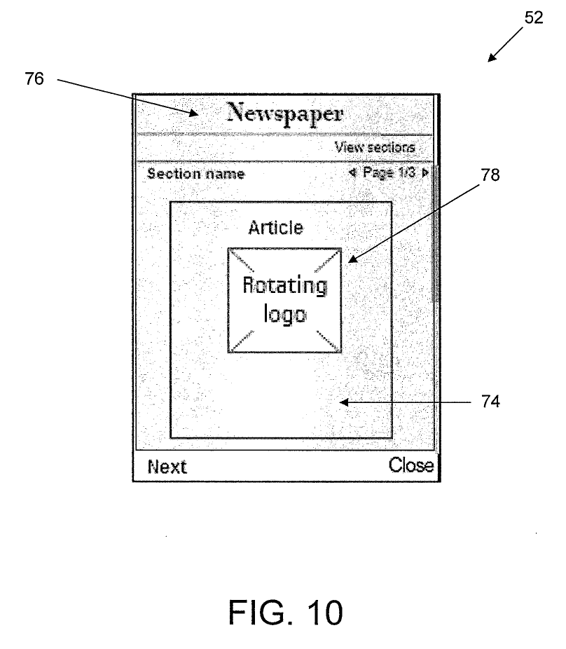

The processing element may be configured to detect the status or orientation of the apparatus and to adjust the provision of advertising content accordingly. For example, if the mobile terminal is upside down, a special advertising mode may be invoked in which the active application 76 is covered by a transparent gray layer 74 and a rotating advertising logo 78 (such as a company name) is provided in the center portion of the display 52, as shown in FIG. 10. As the logo 78 rotates, associated advertising content may be accessed and provided upon the display 52 or saved to the memory to be provided to the user at a later time.

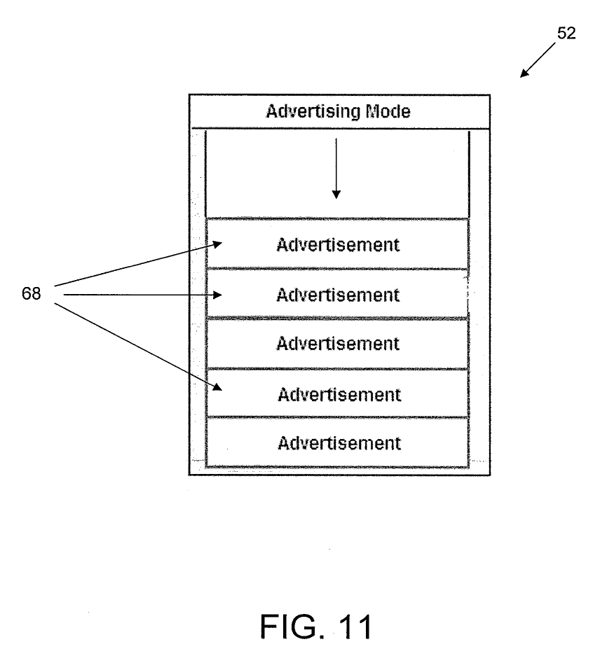

In another embodiment, the advertising mode may involve the provision of advertising content 68 in cascading fashion across the display 52, as shown in FIG. 11, such as moving from the top to the bottom of the display 52. The processing element in this case may configure the soft key(s) to control/access the most recently provided advertisement 68 (e.g., the top-most advertisement in FIG. 11) and/or may allow the user to switch between advertisements 68. The oldest advertisement 68 (e.g., the bottom-most advertisement in FIG. 11) may dissolve or recede from the display 52 once a certain number of advertisements 68 have been collected or after the passage of a certain amount of time to make room for new advertisements. Advertisements that have been removed from the display 52 may be saved in the memory of the apparatus, however, such that a user may be able to access the advertisements if so desired. A user may exit the advertising mode by returning the mobile terminal to the proper orientation (e.g., right-side up) and/or by actuating one of the soft keys configured to exit the advertising mode by the processing element.

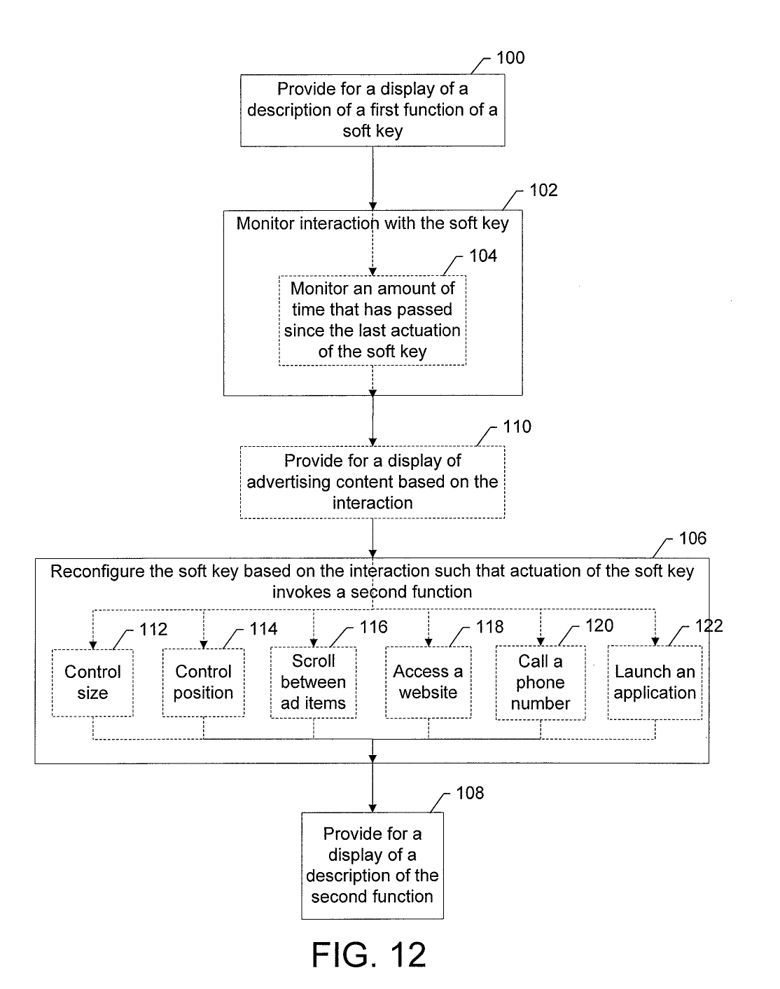

In other embodiments, a method for providing adaptive soft key functionality for display devices is provided. Referring to FIG. 12, a display of a description of a first function of a soft key is provided, and interaction with the soft key is monitored. FIG. 12, blocks 100 and 102. For example, as described above, a soft key may initially be configured to access a list of contacts, in which case a description of “Contacts” may be provided on a portion of the display. Interaction with the soft key is monitored, for example, by monitoring an amount of time that has passed since a last actuation of the soft key. Block 104.

The soft key is then reconfigured based on the interaction such that actuation of the soft key invokes a second, different function. Block 106. A display of the description of the second function is provided, simultaneously with or following reconfiguration of the soft key. For example, the description of the second function may be provided in the soft key description portion of the display, replacing the description of the first function. Block 108. In this way, a user may be aware of the function that is to be invoked when the soft key is actuated. As an example, the soft key may be reconfigured if it has been ten minutes since the user last actuated the soft key, and the soft key may be reconfigured to have a second function that “locks” the mobile terminal such that accidental actuation of the keys would provide no action. Alternatively, the soft key may be reconfigured such that the soft key is disabled.

In some cases, a display of advertising content may be provided based on the interaction. Block 110. For example, if it has been fifteen minutes since the user last interacted with the soft key, various forms of advertising content may be displayed for the user. Reconfiguration of the soft key in this scenario may thus involve allowing the user to control and/or access the advertising content via the soft key's second function.

The soft key may thus be configured to control the size of the advertising content (e.g., maximizing or minimizing the advertisement). Block 112. Or, the soft key may control the position of the advertising content, such that the advertisement may be moved to various locations on the display. Block 114. In some embodiments, the soft key may be configured to have a second function that allows the user to scroll from the displayed advertising content to a different item of advertising content, such as a saved advertisement or a new advertisement acquired from the advertising source, as previously described. Block 116. The soft key may further be configured to permit a user to obtain more information about the advertisement, such as by accessing a website associated with the advertising content and/or calling a phone number associated with the advertising content. Blocks 118 and 120. As another example, the soft key may be configured to launch another application when actuated by the user. Block 122.

Exemplary embodiments of the present invention have been described above with reference to block diagrams and flowchart illustrations of methods, apparatuses, and computer program products. It will be understood that each block of the block diagrams and flowchart illustrations, and combinations of blocks in the block diagrams and flowchart illustrations, respectively, can be implemented by various means including computer program instructions. These computer program instructions may be loaded onto a general purpose computer, special purpose computer, or other programmable data processing apparatus to produce a machine, such that the instructions which execute on the computer or other programmable data processing apparatus create a means for implementing the functions specified in the flowchart block or blocks.

These computer program instructions may also be stored in a computer-readable memory that can direct a computer or other programmable data processing apparatus, such as a processing element including, for example, the controller 20 (shown in FIG. 1) and/or the processing element 56 (shown in FIG. 2), to function in a particular manner, such that the instructions stored in the computer-readable memory produce an article of manufacture including computer-readable instructions for implementing the function specified in the flowchart block or blocks illustrated in FIG. 12. The computer program instructions may also be loaded onto a computer or other programmable data processing apparatus to cause a series of operational steps to be performed on the computer or other programmable apparatus to produce a computer-implemented process such that the instructions that execute on the computer or other programmable apparatus provide steps for implementing the functions specified in the flowchart block or blocks.

Accordingly, blocks of the block diagrams and flowchart illustrations support combinations of means for performing the specified functions, combinations of steps for performing the specified functions and program instruction means for performing the specified functions. It will also be understood that each block of the block diagrams and flowchart illustrations, and combinations of blocks in the block diagrams and flowchart illustrations, can be implemented by special purpose hardware-based computer systems that perform the specified functions or steps, or combinations of special purpose hardware and computer instructions.

Many modifications and other embodiments of the inventions set forth herein will come to mind to one skilled in the art to which these embodiments pertain having the benefit of the teachings presented in the foregoing descriptions and the associated drawings. Therefore, it is to be understood that the inventions are not to be limited to the specific embodiments disclosed and that modifications and other embodiments are intended to be included within the scope of the appended claims. Although specific terms are employed herein, they are used in a generic and descriptive sense only and not for purposes of limitation.

1. A method comprising:
providing for a display of a description of a first function of a soft key in a soft key description area, wherein actuation of the soft key invokes the first function;
monitoring interaction with the soft key;
providing for a display of content in at least the soft key description area based at least in part on the interaction; and
reconfiguring the soft key based on the interaction such that actuation of the soft key invokes a second function;
wherein the first function is different from the second function.

2. The method of claim 1, wherein monitoring interaction with the soft key comprises monitoring an amount of time that has passed since a last actuation of the soft key, and wherein providing for a display of content comprises providing for a display of content after a predetermined amount of time has passed since the last actuation.

3. (canceled)

4. The method of claim 1, wherein reconfiguring the soft key comprises disabling the soft key.

5. The method of claim 1, wherein providing for a display of content comprises providing for a display of advertising content based on the interaction.

6. The method of claim 5, wherein reconfiguring the soft key comprises configuring the soft key to control an aspect of the display of the advertising content selected from the group consisting of a position of the advertising content and a size of the advertising content.

7. (canceled)

8. The method of claim 5, wherein reconfiguring the soft key comprises configuring the soft key to perform a function selected from the group consisting of accessing a website associated with the advertising content and calling a phone number associated with the advertising content.

9. A computer program product comprising at least one computer-readable storage medium having computer-readable program code portions stored therein, the computer-readable program code portions comprising:
a first executable portion for providing for a display of a description of a first function of a soft key in a soft key description area, wherein actuation of the soft key invokes the first function;
a second executable portion for monitoring interaction with the soft key;
a third executable portion for providing for a display of content in at least the soft key description area based at least in part on the interaction; and
a fourth executable portion for reconfiguring the soft key based on the interaction such that actuation of the soft key invokes a second function;
wherein the first function is different from the second function.

10-16. (canceled)

17. An apparatus comprising:
at least one processor
and at least one memory including computer program code
the at least one memory and the computer program code configured to, with the at least one processor, cause the apparatus at least to:
provide for a display of a description of a first function of a soft key in a soft key description area, wherein actuation of the soft key invokes the first function;
monitor interaction with the soft key;
provide for a display of content in at least the soft key description area based at least in part on the interaction; and
reconfigure the soft key based on the interaction such that actuation of the soft key invokes a second function;
wherein the first function is different from the second function.

18. The apparatus of claim 17, wherein the processing element is further configured to monitor an amount of time that has passed since a last actuation of the soft key and to provide for a display of content after a predetermined amount of time has passed since the last actuation.

19. (canceled)

20. The apparatus of claim 17, wherein the processing element is further configured to disable the soft key.

21. The apparatus of claim 17, wherein the processing element is further configured to provide for a display of advertising content based on the interaction.

22. The apparatus of claim 21, wherein the processing element is further configured to configure the soft key to control an aspect of the display of the advertising content selected from the group consisting of a position of the advertising content and a size of the advertising content.

23. (canceled)

24. The apparatus of claim 21, wherein the processing element is further configured to configure the soft key to perform a function selected from the group consisting of accessing a website associated with the advertising content and calling a phone number associated with the advertising content.

25-27. (canceled)

28. The method of claim 1 further comprising providing for a display of a description of the second function in the soft key description area.

29. The method of claim 1, wherein providing for a display of content comprises providing for a display of content in at least the soft key description area that is associated with the position of a user's cursor with respect to other displayed content.

30. The computer program product of claim 9 further comprising a fifth executable portion for providing for a display of a description of the second function in the soft key description area.

31. The computer program product of claim 9, wherein the third executable portion comprises providing for a display of content in at least the soft key description area that is associated with the position of a user's cursor with respect to other displayed content.

32. The apparatus of claim 21, wherein the processing element is further configured to provide for a display of a description of the second function in the soft key description area.

33. The apparatus of claim 21, wherein the processing element is further configured to provide for a display of content in at least the soft key description area that is associated with the position of a user's cursor with respect to other displayed content.

34. The apparatus of claim 1 wherein the apparatus is a mobile terminal.
